(19) United States
(12) Patent Application Publication
(10) Pub. No.: US 2007/0240540 A1
(43) Pub. Date: Oct. 18, 2007

(54) Nail Polish Opener

(76) Inventors: Hue Lily Vujosevic, Pflugerville, TX (US); Ranko Vujosevic, Pflugerville, TX (US)

Correspondence Address: HUE LILY VUJOSEVIC, 206 BETTERMAN DRIVE, PFLUGERVILLE, TX, 78660, US

(21) Appl. No.: 11/308,651

(22) Filed: Apr. 17, 2006

(51) Int. Cl. B67B 7/18; B67B 7/14

(52) U.S. Cl. 81/3.44

(57) ABSTRACT

Nail polish opener is ideally used for fingernail polish bottles. It is available in variety of colors with decals.

### BACKGROUND OF THE INVENTION

Some of the nail polish bottles are small; therefore the caps are small. It is very difficult to open to a small cap by hand because it is hard to grab on the small bottle to open the slippery cap. Sometimes, the nail enamel sticks to the cap that makes it more difficult to open the cap by hand. Users have to pinch their fingers hard to twist the cap opened. With the Nail Polish Opener, nail technicians and end-users can open the nail polish bottle at ease, preventing them from carpal tunnel injury.

### BRIEF DESCRIPTION OF THE DRAWINGS

FIG. 1 is the overall view of bottle opener, closed position.

FIG. 2 is the cross section view of bottle opener, open position.

FIG. 3 is the second embodiment, overall view of bottle opener, closed position.

FIG. 4 is the second embodiment, cross section view of bottle opener, open position.

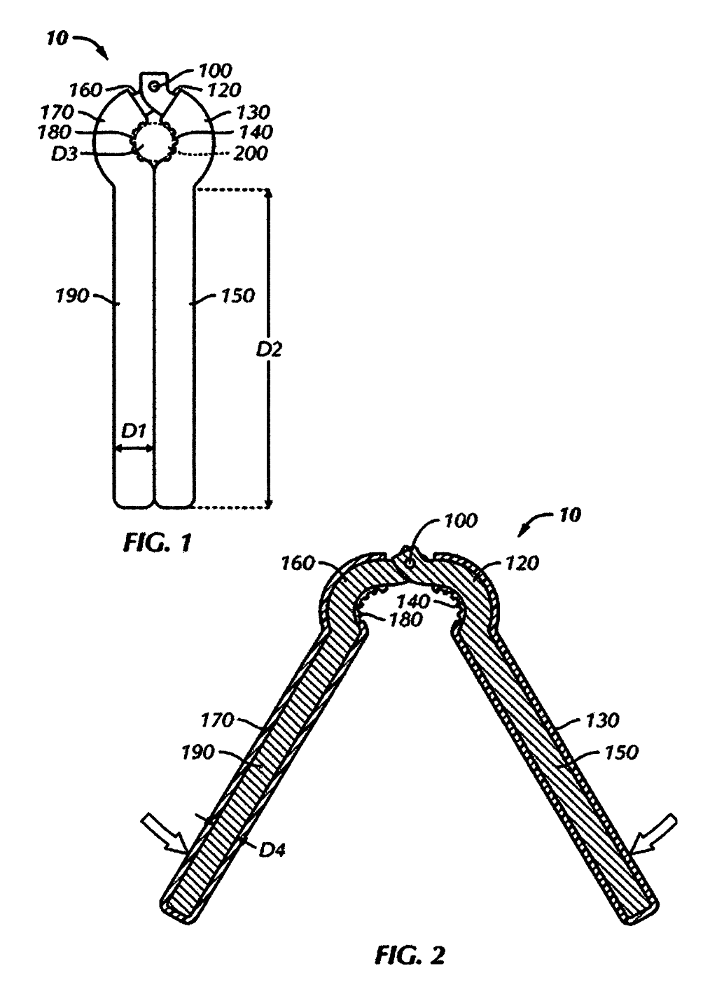

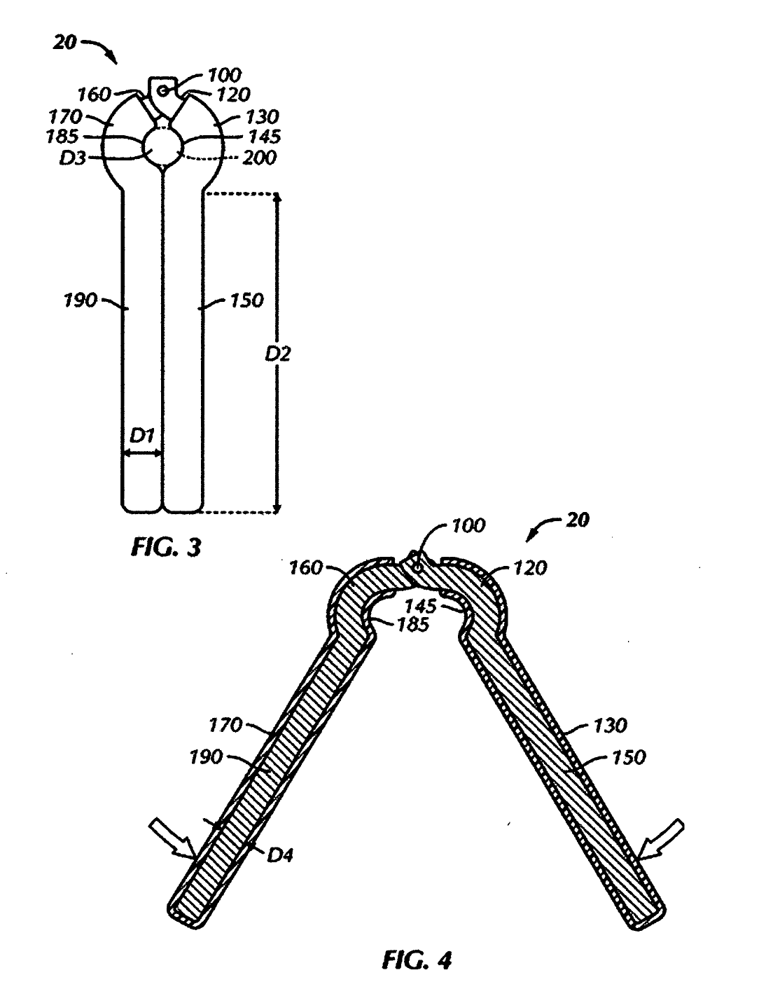

### DETAILED DESCRIPTION OF THE INVENTION

10 is the overall bottle opener.

20 is the overall bottle opener, second embodiment (smooth gripper areas)

100 is the pivot, rivet.

120 is the right arm.

130 is the right arm, soft rubber grip.

140 is the gripper area of soft rubber, right arm.

145 is smooth gripper area of soft rubber, right arm.

150 is the handle, right arm.

160 is the left arm.

170 is the left arm, soft rubber grip.

180 is the gripper area of soft rubber, left arm.

185 is smooth gripper area of soft rubber, left arm.

190 is the handle, left arm.

200 is the bottle cap, phantom.

D1 is the width of handle with grip.

D2 is the length of handles.

D3 is the diameter of closed gripper area.

D4 is the width of handle.

What is claimed is:

1. Nail polish opener consists of the:
right arm,
left arm,
and the pivot (rivet).

2. Right and left arms of the Nail polish opener of claim 1 consists of any type of hard plastic, metal, or other material.

3. Right and left arms of the Nail polish opener of claim 1 consists of any type of soft rubber grip.

4. Nail polish opener of claim 1 consists of any type of pivot rivet.

5. Gripper areas of nail polish opener of claim 1 can be either smooth or any type of bumpy looking.
